(19) United States
(12) Patent Application Publication
(10) Pub. No.: US 2020/0231411 A1
(43) Pub. Date: Jul. 23, 2020

(54) Removable Under-Seat Compartment for Folding Seats and Method

(71) Applicants: Joseph Edward Foggio, JR., Suwanee, GA (US); Guadalupe A. Foggio, Suwanee, GA (US)

(72) Inventors: Joseph Edward Foggio, JR., Suwanee, GA (US); Guadalupe A. Foggio, Suwanee, GA (US)

(21) Appl. No.: 16/271,830

(22) Filed: Feb. 10, 2019

Related U.S. Application Data
(60) Provisional application No. 62/795,223, filed on Jan. 22, 2019.

(51) Int. Cl. B66B 9/08; A61G 5/08; A47C 7/62

(52) U.S. Cl. CPC B66B 9/0853; E04F 2011/0203; A47C 7/626; A61G 5/08

(57) ABSTRACT

A removable under-seat compartment for folding seats that may be used as part of a stair lift and method is disclosed. A compartment bracket having rails is attached to underside of the folding seat that pivots from a horizontal position to a vertical position. The compartment has flaps that engage with rails of the bracket to enable the compartment to enable a user of the stair lift to force the compartment to slide in and out from under the seat when the user is seated on the horizontally positioned folding seat. A stop is provided on the bracket to prevent the flaps on the compartment sliding out of the rails when the seat is pivoted to the vertical position.

### RELATED APPLICATION

This application claims the benefit of U.S. provisional application No. 62/795,223, filed on Jan. 22, 2019, the contents of which are hereby incorporated by reference.

### TECHNICAL FIELD

These claimed embodiments relate to a removable seat compartment for folding seats and more particularly to a compartment box for installing to the underside of a folding seat of a chair lift.

### BACKGROUND OF THE INVENTION

A method for attaching a Removable Under-Seat Compartment to a folding seats and apparatus is disclosed.

Homes and businesses have stairways to allow people to move from one floor to another. When people with physical disabilities have a need to traverse the stars, many people use an electric stair lift. The user sits on the stair lift, straps themselves in, turns the lift on and the lift traverses the stairs along a track. When people with physical disabilities use the star lift often times, they are carrying one or more objects on the lift. Often users drop or lose control of the object during the use of the lift resulting in the user stopping and exiting the lift to retrieve the object. Retrieval of the object mid-flight could present a danger to user that may result in serious injury or death.

### SUMMARY OF THE INVENTION

In one implementation a stair lift is disclosed. The stair lift has a frame coupled with an electrically motorized device and a seat device. The seat device has a foldable seat, a foldable arm rests and a seat backing. The foldable seat has a right side and an opposing left side, a back side and an opposing front side. The foldable seat is operative to pivot along the back side from a horizontal position to a vertical position along an axis disposed below or adjacent a bottom portion of the seat backing. The seat when in the horizontal position is operative to support a user seated on a top surface of the seat. The motorized device has an electric drive system that engages with a track installed adjacent a stairway. Turning the electric drive system on results in the stair lift traveling along the track to move the user sitting on the seat device up and down the stairway. The star lift includes one or more compartment brackets coupled to a bottom surface of the foldable seat. The one or more compartment brackets are coupled with a) a left rail extending along the bottom surface adjacent the left side from the front side toward the back side of the seat, and b) a right rail extending along the bottom surface adjacent the right side from the front side toward the back side of the seat. A compartment having a floor is coupled adjacent the compartment's perimeter to a bottom portion of a) a front side wall and an opposing backside wall, and b) a left side wall and an opposing right side wall. The left side wall and the right side wall each having a top portion with at least one flap to respectively engage with the left rail and the right rail to support the compartment under the seat while enabling the compartment to slide under and out from under the foldable seat. At least one stop is coupled adjacent one end of the one or more compartment brackets. The stop is operable to engage with the compartment when the compartment slides under the foldable seat to prevent the compartment from sliding out of the right rail and left rail when the seat is in the vertical position.

In another implementation, under seat compartment is disclosed for connecting to a seat that folds from a horizontal position to a vertical position, the compartment includes a compartment bracket coupled to a bottom surface of the foldable seat. The compartment bracket is coupled with a) a left rail extending along the bottom surface adjacent a left side from a front side toward a back side of the foldable seat, and b) a right rail extending along the bottom surface adjacent a right side from the front side toward the back side of the seat. A compartment having a floor is coupled adjacent the floor's perimeter to a bottom portion of: a) a front side wall and an opposing backside wall, and b) a left side wall and an opposing right side wall. The left side wall and the right side wall each have a top portion with at least one flap to respectively engage with the left rail and the right rail to support the compartment under the seat while enabling the compartment to slide under and out from under the foldable seat. At least one stop is coupled adjacent one end of the bracket. The stop is operable to engage with the compartment when the compartment slides under the foldable seat to prevent the compartment from sliding out of the right rail and left rail when the seat is in the vertical position.

In addition, a method for constructing a stair lift is disclosed. The method includes attaching to a frame a motorized device and a seat device where the seat device has a foldable seat, foldable arm rests and a seat backing. The foldable seat has a right side and an opposing left side, a back side and an opposing front side. The foldable seat operative to pivot along the back side from a horizontal position to a vertical position along fan axis disposed below or adjacent a bottom portion of the seat backing. The seat when in the horizontal position supporting a user seated on a top surface of the seat. The motorized device has a drive system that engages with a track installed adjacent a stairway. The drive system when turned on results in the stair lift traveling along the track to move the user sitting on the seat device up and down the stairway. One or more compartment brackets are coupled adjacent a bottom surface of the foldable seat. The one or more compartment brackets are connected with a) a left rail extending along the bottom surface adjacent the left side from the front side toward the back side of the seat, and b) a right rail extending along the bottom surface adjacent the right side from the front side toward the back side of the seat. A compartment is provided that has a floor. The floor is coupled, adjacent the floor's perimeter, to a bottom portion of a) a front side wall and an opposing backside wall, and b) a left side wall and an opposing right side wall. The left side wall and the right side wall each have a top portion with at least one flap. The one flap of the left side wall engages with the left rail and the one flap of the right-side wall engages with the right rail to support the compartment under the seat and to enable the user (while seated) to force the compartment to slide under and out from under the foldable seat when the foldable seat is in a horizontal position. At least one stop is coupled adjacent one end of the one or more brackets, such that the stop engages with the compartment when the compartment slides under the foldable seat to prevent gravity causing the flaps from sliding out of the right rail and left rail when the seat is pivoted to the vertical position.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a front view of a stair lift with a Removable Under-Seat Compartment;

FIG. 2 is a side view of a stair lift with the removable under-seat compartment with the seat of the stair lift in a folding position;

FIG. 3a is a bottom view of the removable under-seat compartment and associated bracket for mounting the compartment to a foldable seat;

FIG. 3b is a top view of the removable under-seat compartment;

FIG. 4a is a top view of the removable under-seat compartment and an alternate embodiment of the associated bracket for mounting the compartment to a foldable seat;

FIG. 4b is a side view of the alternate embodiment of the associated bracket for mounting the compartment to a foldable seat shown in FIG. 4a.

FIG. 5 is a flow diagram illustrating the process for constructing a stair lift with a removable under-seat compartment.

### DETAILED DESCRIPTION

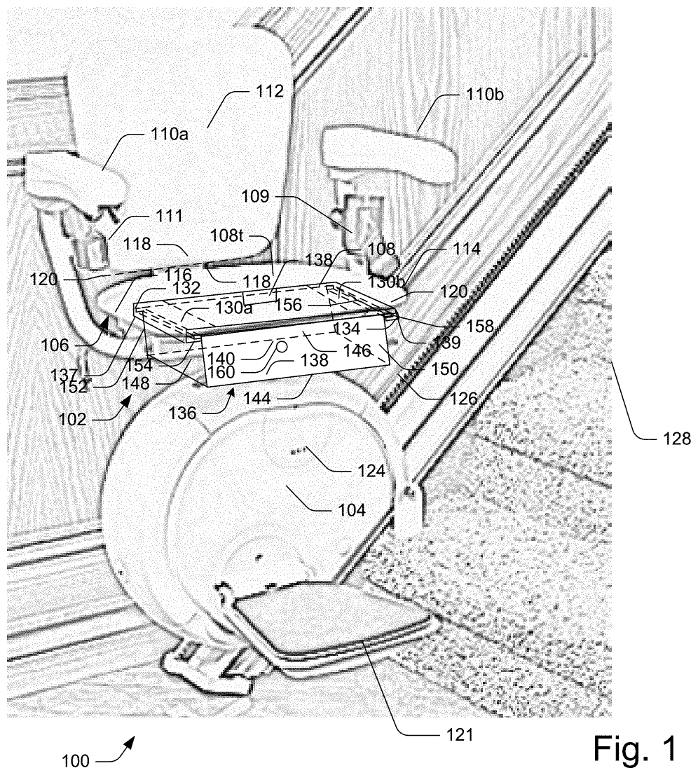

Referring to FIG. 1 there is shown a stair lift 100 having a frame 102 coupled with a motorized device 104 and a seat device 106 in a horizontal position.

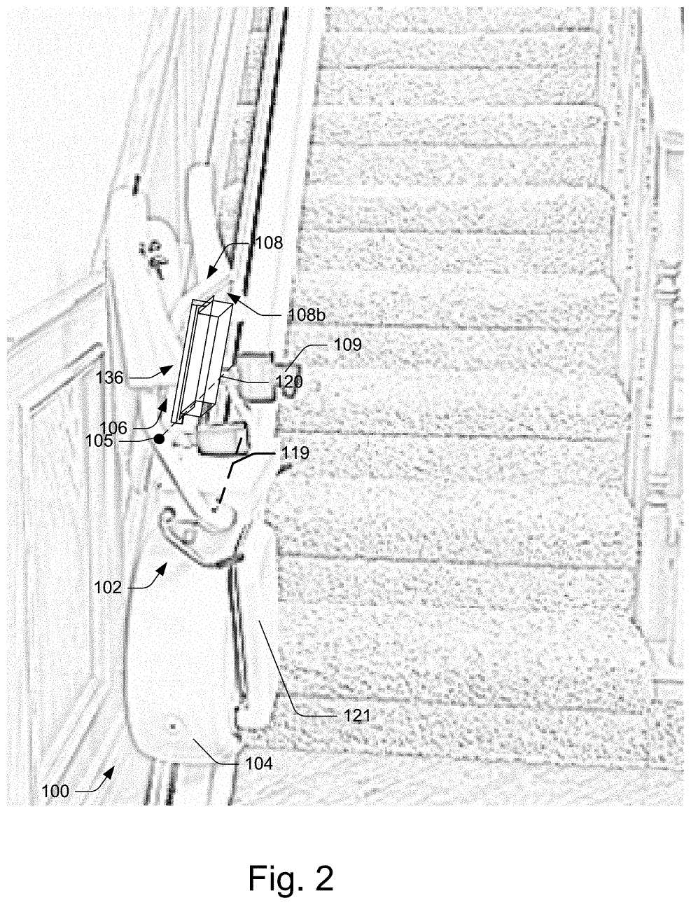

Referring to FIG. 2 there is shown a stair lift 100 having a frame 102 coupled with a motorized device 104 and a seat device 106 in a vertical position.

Referring to FIGS. 1-2, the seat device 106 has a foldable seat 108, foldable arm rests 110a and 110b and a seat backing 112. The foldable seat 108 has a bottom surface 108b, a top surface 108t, a right side 114 and an opposing left side 116, a back side 118 and an opposing front side 120. Frame 102 is connected to foldable footrest 121 that supports the feet of a user sitting on seat 108. A strap 109 is connected to the seat backing and has a connector 111 to secure the foldable seat 108 in the vertical position (FIG. 2).

The foldable seat 108 can pivot along its back side 118 from a horizontal position (FIG. 1) to a vertical position (See FIG. 2) along an axis 120 disposed below or adjacent a bottom portion 122 of the seat backing 112. The seat 108 when in the horizontal position (FIG. 1) can support a user seated on a top surface 108t of the seat 108. The seat 108 is coupled to a rod 105 and rotates around axis 120 extending through the rod 105 when seat 108 is in horizontal position.

The motorized device 104 has a drive system 124 that engages with a track 126 installed adjacent a stairway 128 to cause the star lift 100 to travel along the track 126 to move the user sitting on the seat 108 up and down the stairway 128.

Compartment brackets 130a and 130b are mounted to the stair lift 100 by being coupled to a bottom surface 108b of the foldable seat 108. The compartment brackets 130a and 130b are coupled with a) a left rail 132 extending along the bottom surface 108b adjacent the left side 116 from the front side 120 toward the back side 118 of the seat 108, and b) a right rail 134 extending along the bottom surface 108b adjacent the right side 114 from the front side 120 toward the back side 118 of the seat 108. The compartment brackets 130a and 130b are coupled to a bottom surface of the foldable seat 108 and include a ceiling 136 having a left edge 137 and an opposing right edge 139. Brackets 130a and 130b include a left rail 132 integrally connected to the ceiling 135 along the left edge 137, and the right rail 134 integrally connected to the ceiling 135 along the right edge 139.

Compartment 136 is slidably coupled with compartment brackets 130a and 130b. Compartment 136 has a floor 138 integrally coupled adjacent compartment's perimeter 140 to a bottom portion 142 of a) a front side wall 144 and an opposing backside wall 146, and b) a left side wall 148 and an opposing right side wall 150. The left side wall 148 having a top portion 152 with a flap 154 extending along the length of the left side wall 148. The right-side wall 150 having a top portion 156 with a flap 158 extending along the length of the right side wall 150. Flaps 154 and 158 respectively engage with the left rail 132 and the right rail 134 to support the compartment 136 under the seat 108 while enabling the compartment 136 to slide under and out from under the foldable seat 108. In one implementation a handle 160 is mounted to the front side wall 144 of compartment 136. The compartment 136 rotates with the seat 108 around the axis 111.

A stop 138 is coupled adjacent one end of either of both of the brackets 130a or 130b. The stop 138 engages with the backside wall 146 of the compartment 136 when the compartment 136 slides under the foldable seat 108 to prevent the compartment 136 from sliding out of the right rail 134 and left rail 132 when the seat 138 is in the vertical position (see FIG. 2).

In one implementation, the compartment front side wall 144 slides to be flush with the front of the foldable seat 108 when the compartment 136 is slid completely under the foldable seat 108. Simultaneously the backside wall 146 engages with the stop 138.

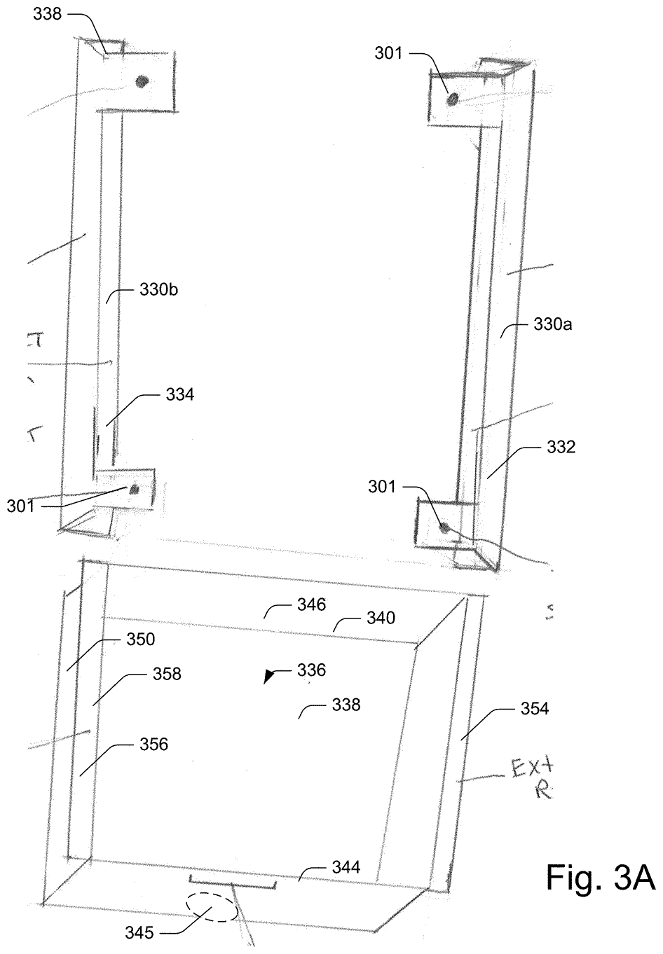

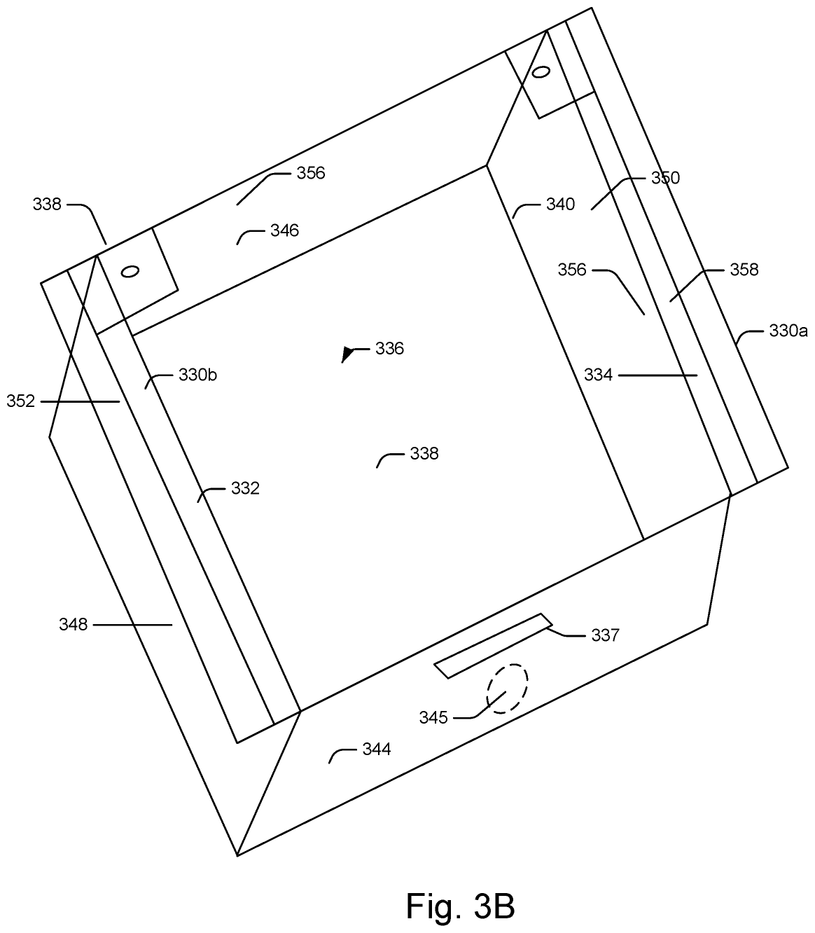

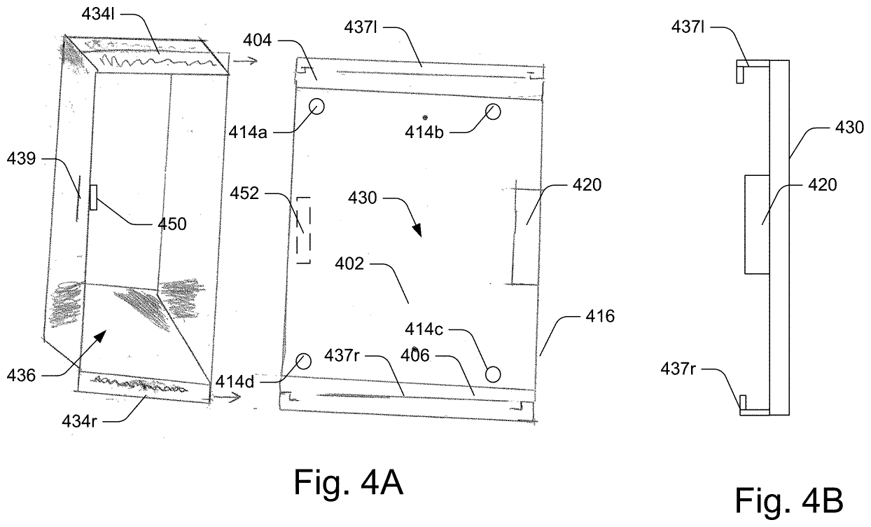

Referring to FIG. 3A-3b, there is shown brackets 300a-b (Brackets 130a and 130b of FIG. 1A-1B) and under-seat compartment 336 (Compartment 136 of FIG. 1-2). Brackets 300a-b connect to underside surface of seat 108 that folds from a horizontal position (FIG. 1) to a vertical position (FIG. 2). Although brackets 300a-300b (and bracket 400 of FIG. 4) with compartment 336 are shown connected to a seat 108, brackets 300a-300b with compartment 336 may be connected to wheelchair seats, riding lawn mowers seats, seats for furniture and under kitchen cabinets tops.

The compartment brackets 300a-b form apertures 301 though which a fastener (not shown) may extend through to couple brackets 300a-b to a bottom surface 108b (FIG. 1-2) of the foldable seat 108. The compartment bracket 300a-b couples with a) a left rail 332 extending along the bottom surface of seat 108 adjacent a left side 316 from a front side 320 toward a back side 318 of the foldable seat 108, and b) a right rail 334 extending along the bottom surface 108b (FIG. 1) of seat 108 adjacent a right side 114 from the front side 114 toward the back side of the seat 108.

Compartment 336 is slidably coupled with compartment brackets 330a and 330b. Compartment 336 has a floor 338 coupled adjacent floor's perimeter 340 to a bottom portion 340 of a) a front side wall 344 and an opposing backside wall 346, and b) a left side wall 348 and an opposing right side wall 350. The left side wall 348 having a top portion 352 with a flap (or extension) 354 extending along the length of the left side wall 348. The right-side wall 350 having a top portion 356 with a flap (or extension) 358 extending along the length of the right side wall 350. Flaps 354 and 358 respectively engage with the left rail 332 and the right rail 334 to support the compartment 336 under the seat 108 while enabling the compartment 336 to slide under and out from under the foldable seat 108. In one implementation compartment 336 has a handle 337 mounted to front side wall 344. In one implementation, the under seat compartment 336 has front side wall 344 that form a round opening 345 through which a tank of oxygen can extend therethrough and rest on the floor 338 of the compartment 336.

A stop 338 is coupled adjacent one end of the compartment bracket 130a and/or 130b. The stop 338 engages with the compartment 336 when the compartment 336 slides under the foldable seat 108 (FIGS. 1-2) to prevent the compartment 336 from sliding out of the right rail 334 and left rail 332 when the seat 108 is in the vertical position (See FIG. 2).

Referring to FIG. 4A there is shown compartment 436 (compartment 136 in FIGS. 1-2, and compartment 336 of FIGS. 3A-3B) that has flaps or extensions 4341 and 434r to slidably engage with rails 437r & 4371 (rails 132 and 134 of FIGS. 1-2) of alternative compartment bracket 430 (bracket 430 replaces brackets 130a-130b of FIGS. 1-2). Referring to FIG. 4B, there is shown a side view of compartment bracket 430 shown in FIG. 4A.

Referring to FIGS. 4A-4B, bracket 430 is coupled the bottom surface 108b of the foldable seat 108 (in FIGS. 1-2) and includes a ceiling 402 having a left edge 404 and an opposing right edge 406. Bracket 430 has a left rail 4371 integrally connected to the ceiling 402 along the left edge 404, and the right rail 437r integrally connected to the ceiling 402 along the right edge 412.

Compartment 436 includes a handle with a locking mechanism 439 coupled with the front side wall 448 (Wall 148 of FIG. 1-2). The locking mechanism 439 has a rotatable plate 450 that engages with a detent 452 carved out of the ceiling 402 to prevent the compartment 436 from sliding in the rails 437r and 437r.

Ceiling 402 includes a plurality of apertures 414a-d through which one or more screws or fasteners (not shown) can be inserted to couple ceiling 402 to the bottom of the seat 108. Ceiling 402 includes a rear edge 416 between the right edge 406 and the left edge 404. The ceiling 402 forms the stop 420 along a rear edge 406.

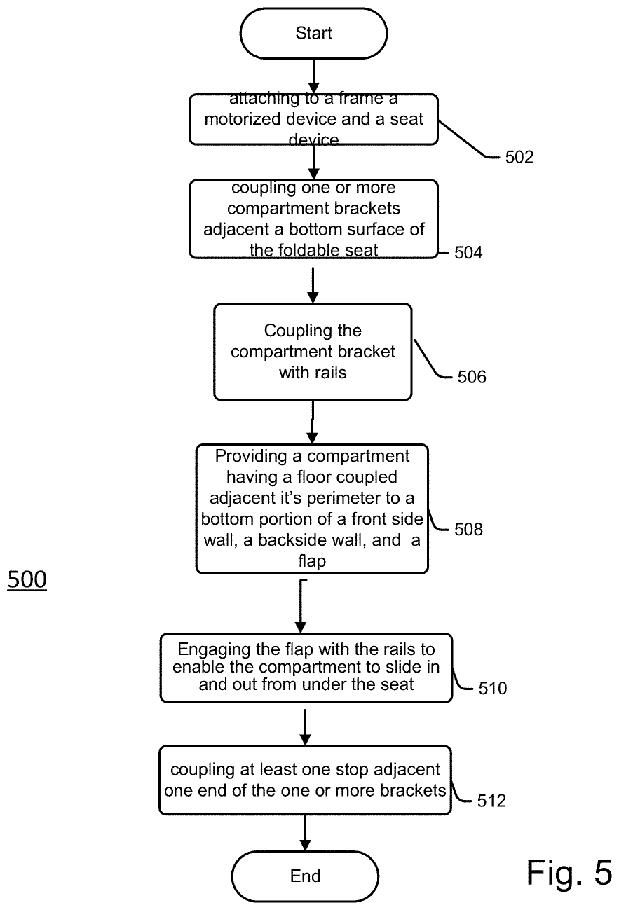

Illustrated in FIG. 5 is a process 400 for constructing a stair lift 100. The exemplary process in FIG. 5 is illustrated as a collection of blocks in a logical flow diagram, which represents a sequence of operations that can be implemented using common tools. The order in which the operations are described is not intended to be construed as a limitation, and any number of the described blocks can be combined in any order and/or in parallel to implement the process. For discussion purposes, the processes are described with reference to FIGS. 1-4, although it may be implemented in other ways.

Referring to FIG. 5, a flow diagram 500 of a method for constructing a stair lift 100 (FIG. 1-2) is shown using generally known tools.

In block 502, a frame 102 is attached to a motorized device 104 and a seat device 106. Referring to FIG. 1, the seat device 106 has a foldable seat 108, foldable arm rests 110 and a seat backing 112. The foldable seat 108 has a right side and an opposing left side, a back side and an opposing front side, the foldable seat 108 operative to pivot along the back side from a horizontal position to a vertical position along an axis disposed below or adjacent a bottom portion of the seat backing. The seat 108 when in the horizontal position operative to support a user seated on a top surface of the seat 108. The motorized device 104 has a drive system that engages with a track installed adjacent a stairway. The drive system 124 when engaged resulting in the stair lift 100 traveling along the track 126 to move the user sitting on the seat 108 up and down the stairway 128. In one implementation, the foldable seat 108 is operative to pivot along the back side from a horizontal position (FIG. 1) to a vertical position (Fig.) along a rod through which the axis extends there through. In another implementation the rod is disposed below or adjacent a bottom portion of the seat backing.

In block 504, one or more compartment brackets 130a and 130b (or bracket 330) are coupled adjacent a bottom surface 108b of the foldable seat 108.

In block 506, the flaps of compartment brackets 300a-300b are coupled with a left rail and right rail. The left rail operative to extend along the bottom surface adjacent the left side from the front side toward the back side of the seat when the one or more compartment brackets 100a-100b are coupled adjacent a bottom surface of the foldable seat 108. The right rail extends along the bottom surface of seat 108 adjacent the right side from the front side toward the back side of the seat 108 when the compartment brackets 300a-300b are coupled adjacent a bottom surface of the foldable seat 108.

In block 508, a compartment 136 is provided with flaps for slidably coupling with compartment brackets 130a and 130b. Compartment 136 has a floor 138 integrally coupled adjacent compartment's perimeter 140 to a bottom portion 142 of a) a front side wall 144 and an opposing backside wall 146, and b) a left side wall 148 and an opposing right side wall 150. The left side wall 148 has a top portion 152 with a flap 154 extending along the length of the left side wall 148. The right-side wall 150 has a top portion 156 with a flap 158 extending along the length of the right side wall 150. In one implementation the compartment has a handle 160 on the front side wall 144.

In block 510, the flap 154 of the left side wall 148 engages with the left rail 132 and the flap 158 of the right-side wall engages with the right rail to support the compartment 136 under the seat 108 and to enable the user seated in the seat 108 to force the compartment 136 to slide under and out from under the foldable seat 108 when the user is seated on the foldable seat 108 in a horizontal position (FIG. 1).

In block 512, at least one stop 138 is coupled adjacent one end of the one or more brackets 300a-300b. The stop 138 engages with the compartment 136 when the compartment 136 slides under the foldable seat 108 to prevent gravity from causing the flaps 154 to slide out of the right rail and left rail when the seat 108 is pivoted to the vertical position.

In a further implementation, one end of a foldable plate (not shown) having a top surface and a bottom surface is attached to a rod 105, and the top surface of the foldable plate is positioned adjacent the bottom surface of the foldable seat 108. Compartment brackets 300 are coupled to the bottom surface of the foldable plate adjacent a bottom surface of the foldable seat 108.

In another implementation, the compartment bracket 430 (FIG. 4) is coupled to a bottom surface of the foldable seat 108, wherein the compartment brackets 430 includes a ceiling 402 having a left edge 404 and an opposing right edge 412. The left rail 408 is integrally coupled to the ceiling 402 along the left edge 404. The right rail 410 is integrally connected to the ceiling 402 along the right edge 412.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A stair lift having a frame coupled with a motorized device and a seat device, the seat device having a foldable seat, foldable arm rests and a seat backing, the foldable seat having a right side and an opposing left side, a back side and an opposing front side, the foldable seat operative to pivot along the back side from a horizontal position to a vertical position along an axis disposed below or adjacent a bottom portion of the seat backing, the seat when in the horizontal position is operative to support a user seated on a top surface of the seat, the motorized device having a drive system that engages with a track installed adjacent a stairway to cause the star lift to travel along the track to move the user sitting on the seat device up and down the stairway, the star lift comprising:
one or more compartment brackets coupled to a bottom surface of the foldable seat, the one or more compartment brackets coupled with a) a left rail extending along the bottom surface adjacent the left side from the front side toward the back side of the seat, and b) a right rail extending along the bottom surface adjacent the right side from the front side toward the back side of the seat;
a compartment having a floor coupled adjacent it's perimeter to a bottom portion of a) a front side wall and an opposing backside wall, and b) a left side wall and an opposing right side wall, the left side wall and the right side wall each having a top portion with at least one flap to respectively engage with the left rail and the right rail to support the compartment under the seat while enabling the compartment to slide under and out from under the foldable seat; and
at least one stop coupled adjacent one end of the one or more brackets, the stop operable to engage with the compartment when the compartment slides under the foldable seat to prevent the compartment from sliding out of the right rail and left rail when the seat is in the vertical position.

2. The stair lift as recited in claim 1, wherein the stair lift comprises a strap connected the seat back and having a connector to secure the foldable seat in the vertical position.

3. The stair lift as recited in claim 1, wherein the one or more compartment brackets coupled to a bottom surface of the foldable seat includes a ceiling having a left edge and an opposing right edge, the left rail integrally connected to the ceiling along the left edge, and the right rail integrally connected to the ceiling along the right edge.

4. The stair lift as recited in claim 3, wherein the ceiling includes a plurality of apertures through which one or more screws can be inserted to couple the ceiling to the bottom of the seat.

5. The stair lift as recited in claim 3, wherein the ceiling includes a rear edge between the right edge and the left edge, and wherein the ceiling forms the stop along a rear edge.

6. The stair lift as recited in claim 1, further comprising a locking mechanism coupled with the front side wall, the locking mechanism having a rotatable plate that engages with a detent in the ceiling to prevent the compartment from sliding in the rails.

7. The stair lift as recited in claim 1, wherein the compartment front side wall flush with the front of the foldable seat when the compartment is slid complete under the foldable seat such that the back side wall engages with the stop.

8. The stair lift as recited in claim 1, wherein the seat is coupled to a rod and rotates around axis extending through the rod when seat is in horizontal position, the compartment rotating with the seat around the axis.

9. An under seat compartment for connecting to a seat that folds from a horizontal position to a vertical position, the compartment comprising:
at least one compartment bracket coupled to a bottom surface of the foldable seat, the compartment bracket coupled with a) a left rail extending along the bottom surface adjacent a left side from a front side toward a back side of the foldable seat, and b) a right rail extending along the bottom surface adjacent a right side from the front side toward the back side of the seat;
a compartment having a floor coupled adjacent it's perimeter to a bottom portion of a) a front side wall and an opposing backside wall, and b) a left side wall and an opposing right side wall, the left side wall and the right side wall each having a top portion with at least one flap to respectively engage with the left rail and the right rail to support the compartment under the seat while enabling the compartment to slide under and out from under the foldable seat; and
at least one stop coupled adjacent one end of the compartment bracket, the stop operable to engage with the compartment when the compartment slides under the foldable seat to prevent the compartment from sliding out of the right rail and left rail when the seat is in the vertical position.

10. The under seat compartment as recited in claim 9, wherein the at least one compartment bracket coupled to a bottom surface of the foldable seat includes a ceiling having a left edge and an opposing right edge, the left rail integrally connected to the ceiling along the left edge, and the right rail integrally connected to the ceiling along the right edge.

11. The under seat compartment recited in claim 10, wherein the ceiling includes a plurality of apertures through which one or more screws can be inserted to couple the ceiling to the bottom surface of the seat.

12. The under seat compartment as recited in claim 10, wherein the ceiling includes a rear edge extending between the right edge and the left edge, and wherein the ceiling forms the stop along a rear edge.

13. The under seat compartment as recited in claim 10, wherein the front side wall forms an opening through which a tank of oxygen can extend therethrough and rest on the floor of the compartment.

14. A method for constructing a stair lift comprising:
attaching to a frame a motorized device and a seat device, the seat device having a foldable seat, foldable arm rests and a seat backing, the foldable seat having a right side and an opposing left side, a back side and an opposing front side, the foldable seat operative to pivot along the back side from a horizontal position to a vertical position along an axis disposed below or adjacent a bottom portion of the seat backing, the seat when in the horizontal position operative to support a user seated on a top surface of the seat, the motorized device having a drive system that engages with a track installed adjacent a stairway, the drive system when engaged resulting in the stair lift traveling along the track to move the user sitting on the seat device up and down the stairway;
coupling one or more compartment brackets adjacent a bottom surface of the foldable seat;
coupling the one or more compartment brackets with a left rail and right rail, the left rail operative to extend along the bottom surface adjacent the left side from the front side toward the back side of the seat when the one or more compartment brackets are coupled adjacent a bottom surface of the foldable seat, and the right rail to extend along the bottom surface adjacent the right side from the front side toward the back side of the seat when the one or more compartment brackets are coupled adjacent a bottom surface of the foldable seat;
providing a compartment having a floor coupled adjacent it's perimeter to a bottom portion of a) a front side wall and an opposing backside wall, and b) a left side wall and an opposing right side wall, the left side wall and the right side wall each having a top portion with at least one flap;
engaging the at least one flap of the left side wall with the left rail and engaging the at least one flap of the right-side wall with the right rail to support the compartment under the seat and to enable the user in the seat to force the compartment to slide under and out from under the foldable seat when the user is seated on the foldable seat in a horizontal position; and
coupling at least one stop adjacent one end of the one or more brackets, such that the stop engages with the compartment when the compartment slides under the foldable seat to prevent gravity from causing the flaps to slide out of the right rail and left rail when the seat is pivoted to the vertical position.

16. The method as recited in claim 15, wherein the foldable seat operative to pivot along the back side from a horizontal position to a vertical position along an axis disposed below or adjacent a bottom portion of the seat backing further comprises:
a foldable seat operative to pivot along the back side from a horizontal position to a vertical position along a rod through which the axis extends there through, and wherein the rod is disposed below or adjacent a bottom portion of the seat backing.

17. The method as recited in claim 16 further comprising:
attaching one end of a foldable plate having a top surface and a bottom surface to a rod, and positioning the top surface of the foldable plate adjacent the bottom surface of the foldable seat; and
coupling the one or more compartment brackets to the bottom surface of the foldable plate adjacent a bottom surface of the foldable seat.

18. The method as recited in claim 16 further comprising:
coupling the at least one compartment bracket to a bottom surface of the foldable seat, wherein the at least one compartment bracket includes a ceiling having a left edge and an opposing right edge;
Integrally connecting the left rail to the ceiling along the left edge; and
integrally connecting the right rail to the ceiling along the right edge.
